(19) United States
(12) Patent Application Publication
(10) Pub. No.: US 2010/0064064 A1
(43) Pub. Date: Mar. 11, 2010

(54) IMAGE PROCESSING APPARATUS AND IMAGE PROCESSING METHOD

(75) Inventor: Shinji Koizumi, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/556,012

(22) Filed: Sep. 9, 2009

Related U.S. Application Data
(60) Provisional application No. 61/095,488, filed on Sep. 9, 2008.

(51) Int. Cl. G06F 3/00; G06F 13/12

(52) U.S. Cl. 710/13; 710/63

(57) ABSTRACT

A digital multi-function peripheral as an image processing apparatus stores configuration history files representing contents of processes executed in the past into an external storage device connectable to an external I/F. If the external storage device is connected to the external I/F, the configuration history files are acquired from the external storage device, and process contents represented by the configuration history files acquired from the external storage device connected to the external I/F are presented as past process contents to the user. If the user selects one process content from the presented past process contents, the same configuration as the selected process content is performed.

### CROSS-REFERENCE TO RELATED APPLICATION

This application claims the benefit of U.S. Provisional Application No. 61/095,488, filed Sep. 9, 2008.

### TECHNICAL FIELD

The present invention relates to an image processing apparatus, such as a copier, a scanner, a printer, a facsimile or a digital multi-function peripheral, having a connection function to an external storage device, such as a USB (Universal Serial Bus) memory device, owned by a user.

### BACKGROUND

In recent years, image processing apparatuses, such as copiers, scanners, printers, facsimiles or digital multi-function peripherals, having various functions increase in number. In the image processing apparatus such as the digital multi-function peripheral, as more various functions are provided, the operation and configuration tends to become complicated. For example, with respect to such a complicated configuration that the user specifies plural configuration contents, even if the same configuration as the configuration performed in the past is desired to be performed, the operation of the configuration is not simple, and much labor is required.

Besides, in recent years, the image processing apparatuses, such as the digital multi-function peripherals, having a connection function (external interface) to an external storage device increase in number. For example, many recent digital multi-function peripherals include, as an external interface, a USB interface for connection of a USB memory device as an external storage device owned by the user. The digital multi-function peripheral including the USB interface has a function using the USB memory connected by the user to the USB interface.

For example, the digital multi-function peripheral including the USB interface has a function (USB Direct print function) to print image data stored in the USB memory connected by the user to the USB interface. Besides, the digital multi-function peripheral including the USB interface has a function (SCAN to USB Memory function) to store image data obtained by scanning an original document into the USB memory connected by the user to the USB interface.

In the digital multi-function peripheral having the foregoing function, after the USB memory owned by the user is mounted on the USB interface, the user performs an operation for executing the function using the USB memory. However, in the related art digital multi-function peripheral, the operation procedure in the operation panel is not necessarily simple.

### SUMMARY

According to an aspect of the invention, an image processing apparatus for processing image data includes an interface configured to connect to an external storage device, an acquisition section configured to acquire a configuration history file representing a past executed process content stored in the external storage device connected to the interface, a configuration section configured to perform configuration for performing a same process as the process content represented by the configuration history file acquired by the acquisition section from the external storage device connected to the interface, and a processing section configured to process image data in accordance with the process content configured by the configuration section.

According to another aspect of the invention, an image processing method includes acquiring a configuration history file representing a past executed process content from an external storage device connected to an interface, performing configuration for performing a same process as the process content represented by the configuration history file acquired from the external storage device connected to the interface, and processing image data in accordance with the configured process content.

Additional objects and advantages of the invention will be set forth in the description which follows, and in part will be obvious from the description, or may be learned by practice of the invention. The objects and advantages of the invention may be the realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an outer appearance structural example of a digital multi-function peripheral (MFP) as an image processing apparatus including an interface to which an external storage device can be connected.

FIG. 2 is a block diagram schematically showing a structural example of the digital multi-function peripheral.

FIG. 3 is a flowchart for explaining a first operation example.

FIG. 4 is view showing a display example in which a history button is displayed on a main menu screen.

FIG. 5 is a view showing a display example in which past process contents based on configuration history files read from an external storage device are listed.

FIG. 6 is a view showing a display example of a guidance representing a configuration content reflecting a process content selected by the user.

FIG. 7 is a view showing a display example of a configuration screen of a SCAN to USB Memory function.

FIG. 8 is a view showing a display example of a case where there are plural functions executable by using an external storage device connected to an external I/F.

FIG. 9 is a view showing a display example of a configuration screen of a USB Direct Print function.

FIG. 10 is a flowchart for explaining a second operation example.

### DETAILED DESCRIPTION

Hereinafter, embodiments of the invention will be described in detail with reference to the drawings.

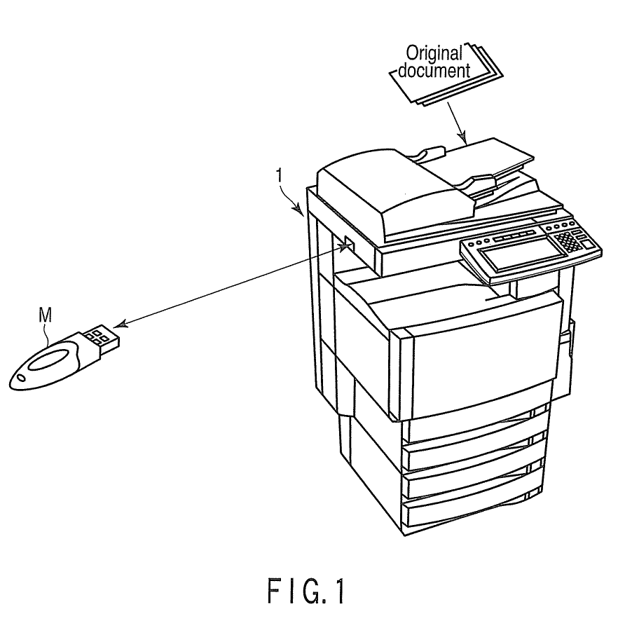

FIG. 1 is a view showing an outer appearance structural example of a digital multi-function peripheral (MFP) as an image processing apparatus 1 including an interface to which an external storage device M can be connected. The digital multi-function peripheral 1 has functions as a copier, a printer, a scanner, a facsimile, or a network communication device. For example, the digital multi-function peripheral 1 executes a process such as scanning, printing or copying in response to an operation of a user.

Besides, the digital multi-function peripheral 1 includes an external interface to which the user directly connects an external storage device M. The external storage device M is an electric device which is connected by the user to the external interface of the digital multi-function peripheral 1. For example, the external storage device M is a potable external storage device such as a memory device (USB memory device, memory card, etc.), a mobile PC, a personal digital assistant, a cellular phone, or an IC card. That is, the external storage device M has only to have a data communication function corresponding to the external interface provided in the digital multi-function peripheral 1. The digital multi-function peripheral 1 may be provided with plural interfaces in order to support external storage devices of various data communication systems.

As a function executable by using the external storage device M, the digital multi-function peripheral 1 has, for example, a function (Direct Print) to print image data stored in the external storage device M, or a function (SCAN to external storage device) to store scanned image data into the external storage device M. For example, the “direct print” is the function to capture the image data from the external storage device M and to print an image on a sheet. Besides, the “SCAN to external storage device” is the function to store the image data obtained by scanning an original document into the external storage device M. Besides, the external storage device M may be used for performing user authentication or may be used for storing configuration information or the like.

Next, the structure of the digital multi-function peripheral 1 will be described.

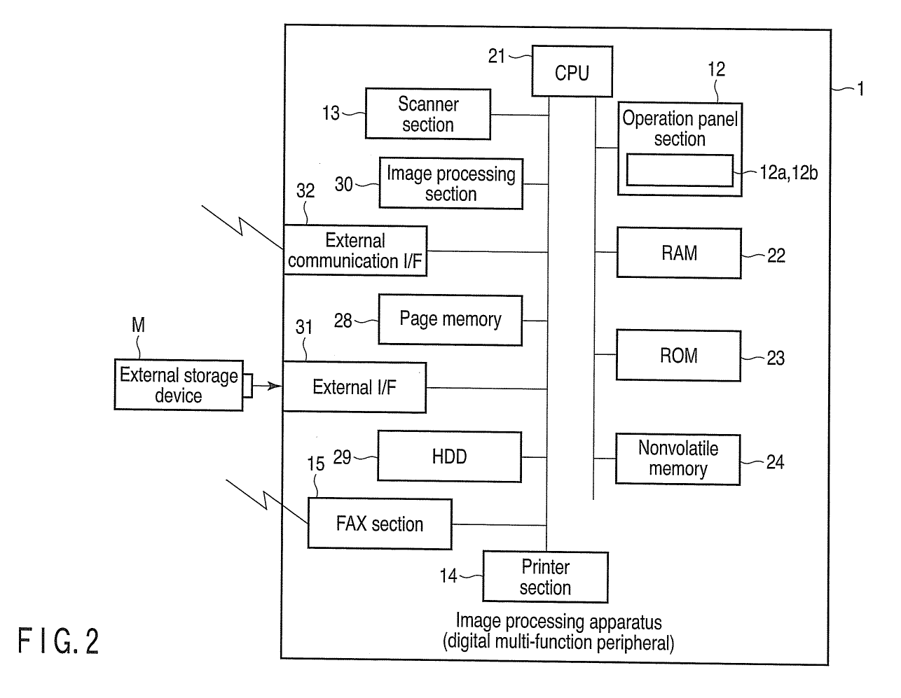

FIG. 2 is a block diagram schematically showing a structural example of the digital multi-function peripheral 1.

As shown in FIG. 2, the digital multi-function peripheral 1 includes an operation panel 12, a scanner section 13, a printer section 14, a facsimile (FAX) section 15, a CPU (Central Processing Unit) 21, a RAM (Random Access Memory) 22, a ROM (Read Only Memory) 23, a nonvolatile memory 24, a page memory 28, a hard disk drive (HDD) 29, an image processing section 30, an external interface (I/F) 31, and an external communication interface (I/F) 32.

The operation panel 12 is a user interface to which an operation instruction from a user is inputted. The operation panel 12 includes hard keys such as a numeric keypad, and a display section 12a having a built-in touch panel 12b. An operation guidance, or a touch key (icon) selectable by the touch panel 12b is displayed on the display section 12a of the operation panel 12. For example, the operation panel 12 detects through the touch panel 12b that the user touches a touch key (icon) displayed on the display section 12a. In this case, the operation panel 12 notifies the CPU 21 of the result of detection of the touch on the touch key.

The scanner section 13 functions as an image reading section to convert an image on an original document surface into image data. The scanner section 13 converts, for example, the image of the original document into color or monochrome digital image data. The scanner section 13 includes a scanning section (not shown) to optically scan the original document surface, and a photoelectric conversion section (not shown), such as a CCD line sensor, to convert reflected light from the original document surface optically scanned by the scanning section into an electric signal.

The printer section 14 forms an image on a sheet as an image forming medium. The printer section 14 includes a conveyance section (not shown) to convey the sheet, and an image formation section (not shown) to form a color image or a monochrome image on the sheet conveyed by the conveyance section. The printer section 14 prints the image data onto the sheet based on the control of the CPU 21. For example, in a copy process, the printer section 14 prints the image data read from the original document by the scanner section 13 onto the sheet. Besides, in a print process, the printer section 14 prints the image data inputted through the external I/F or the external communication I/F 32 onto the sheet.

The facsimile section 15 transmits and receives image data through a public line. For example, the facsimile section 15 transmits the image data read by the scanner section 13, as facsimile data, to a transmission destination specified by a telephone number. Besides, the facsimile section 15 receives facsimile data from a transmission source at a telephone number assigned to the digital multi-function peripheral 1. The facsimile section 15 prints the image data as the received facsimile data by the printer section 14.

The CPU 21 controls the whole digital multi-function peripheral 1. The CPU 21 executes control programs stored in the ROM 23, the nonvolatile memory 24 or the HDD 29 and realizes various processes and various functions. For example, the CPU 21 controls the scanner section 13 and the printer section 14 by the control program for copying and realizes the copy process. Besides, the CPU 21 controls the external communication I/F or the external I/F and the printer section 14 by the control program for printing and realizes the print process.

The RAM 22 is a memory for temporarily storing data for working or data for reference. The ROM 23 is a nonvolatile memory that can not be rewritten. The ROM 23 stores, for example, a control program for controlling the digital multi-function peripheral 1, control data and the like. The nonvolatile memory 24 is a nonvolatile memory that can be rewritten. The nonvolatile memory 24 is constructed of an EEPROM or flash ROM. The nonvolatile memory 24 stores, for example, system configuration information.

The page memory 28 is a memory including a storage area in which image data of at least one page is expanded. The HDD 29 is a large capacity storage device. The HDD 29 is used also as a memory for backup of various data. The HDD 29 stores various configuration data or management data. The HDD 29 stores also data received through the external I/F 31 or the external communication I/F 32 or image data read by the scanner section 13 as the need arises. Besides, the HDD 29 may store authentication information for user authentication.

The image processing section 30 performs various image processes on the image data. The image processing section 30 performs, for example, an image process such as correction, compression or expansion of image data. For example, if the image processing section 30 functions as an image processing section for a scanner, the image processing section 30 performs an image process, such as shading correction, gradation correction or inter-line correction, on the image data read by the scanner section 13. The image processing section 30 may perform image processes on image data read from the page memory 28, image data read from the HDD 29, image data inputted through the external I/F 31, or image data inputted through the external communication I/F 32.

The external I/F 31 is an interface for performing input and output of data to and from the external storage device M connected by the user. The external I/F 31 is constructed of an interface corresponding to the connection system of the external storage device M. The external I/F 31 may be an interface to input and output data by physical contact, or may be an interface to perform input and output data by wireless communication. For example, as the former, a USB interface and the like are named, and as the latter, a Bluetooth interface and the like are named. Incidentally, in this embodiment, it is assumed that the external I/F 31 is the USB interface to which the USB memory device as the external storage device M is connected.

The external communication I/F 32 is an interface for performing network communication. The external communication I/F 32 is the interface for data communication with a device connected to a local area network (LAN) by a network cable or wireless communication.

Next, a first operation example of the digital multi-function peripheral 1 will be described.

First, the first operation example will be schematically described. In the first operation example, the digital multi-function peripheral 1 can be configured based on the information stored in the external storage device M connected to the external I/F 31. In the first operation example described below, a mode is mainly assumed in which the user uses the digital multi-function peripheral 1 in the state where the USB memory M as the external storage device is connected to the USB interface as the external I/F 31.

That is, the digital multi-function peripheral 1 in the state where the USB memory M is connected creates a configuration history file of information representing executed process contents. The digital multi-function peripheral 1 stores the configuration history file created based on the executed process contents (executed function, execution date, various configuration information) into the USB memory M.

Besides, the digital multi-function peripheral 1 has a function to present the user with the configuration history file stored in the USB memory M connected to the external I/F 31 as the past process contents. That is, the digital multi-function peripheral 1 displays the past process contents represented by the configuration history file read from the USB memory M on the display section 12a of the operation panel 12 in a list form. The user uses the touch panel 12b to select a desired process content from the past process contents displayed on the display section 12a. If the user selects the desired process content from the past process contents, the digital multi-function peripheral 1 performs various configurations in accordance with the process content (that is, the configuration history file) selected by the user.

Next, an operation procedure of the first operation example in the digital multi-function peripheral 1 will be described in detail.

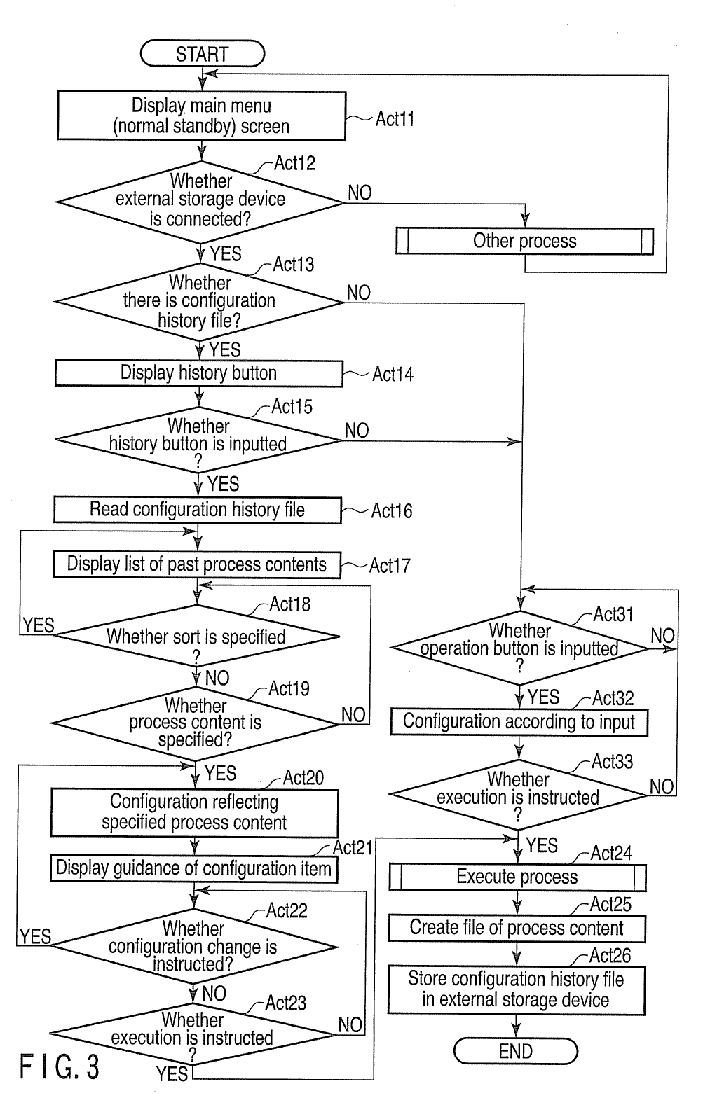

FIG. 3 is a flowchart for explaining the first operation example.

First, the digital multi-function peripheral 1 displays a main menu screen (standby screen) on the display section 12a of the operation panel 12 in a standby state (Act 11). In this state, the CPU 21 of the digital multi-function peripheral 1 detects whether or not the external storage device M is connected to the external I/F 31 (Act 12). If an operation instruction is received from the user while the connection of the external storage device M is not detected (that is, in the state where the external storage device M is not connected), the digital multi-function peripheral 1 performs a process corresponding to the operation instruction from the user.

If the user connects the external storage device M to the external I/F 31, the CPU 21 detects that the external storage device M is connected to the external I/F (Act 12, YES). In this case (Act 12, YES), the CPU 21 determines whether or not the external storage device M connected to the external I/F 31 stores a configuration history file representing a past process content (Act 13). If it is determined by this determination that the external storage device M connected to the external I/F 31 stores the configuration history file (Act 13, YES), the CPU 21 displays a history button 41 on the main menu screen displayed on the display section 12a of the operation panel 12 (Act 14).

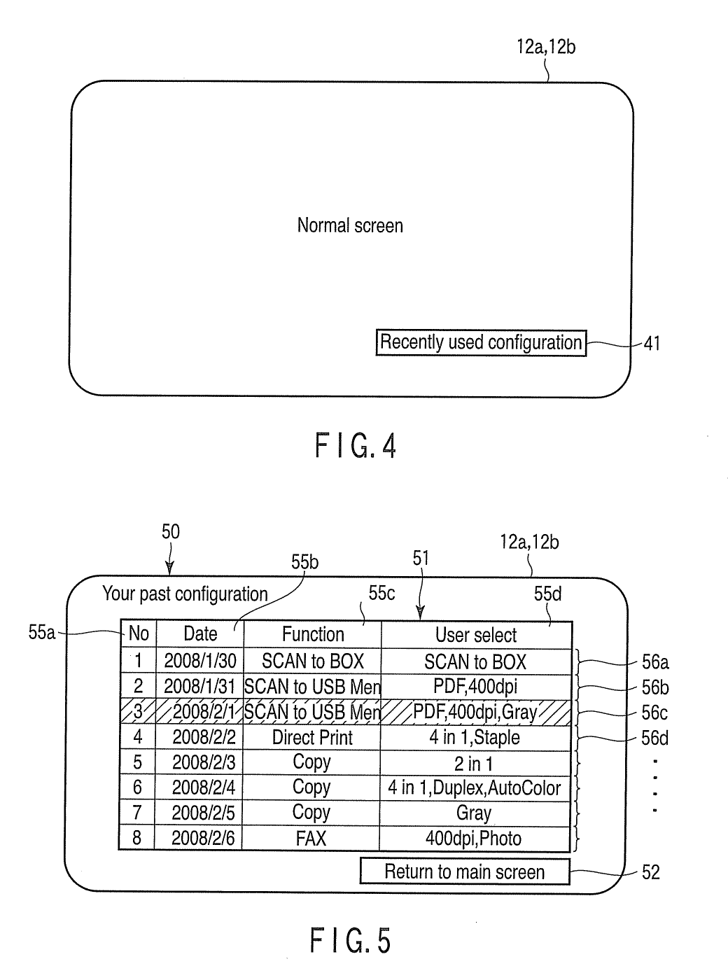

FIG. 4 is a view showing a display example in which the history button 41 is displayed on the main menu screen. In the display example shown in FIG. 4, the history button 41 is an icon shown as “recently used configuration”. The history button 41 is instructed by the user through the touch panel 12b. The history button 41 instructs to display information of configuration contents relating to processes performed in the past. That is, if referring to the process contents performed in the past, the user touches the history button 41 displayed on the display section 12a of the operation panel 12.

If the history button 41 is inputted (Act 15, YES), the CPU 21 reads the configuration history file from the external storage device M connected to the external I/F 31 (Act 16). If at least one configuration history file is read from the external storage device M, the CPU 21 creates a list in which the process content represented by the read configuration history file is the past process content. If the list of the past process contents is created, the CPU 21 displays the created list on the display section 12a of the operation panel 12 (Act 17). In the list displayed on the display section 12a, the display part of each of the process contents can be selected by the user through the touch panel 12b.

FIG. 5 shows a display example in which the past process contents based on the configuration history files read from the external storage device M are displayed in a list. In the display example shown in FIG. 5, the display section 12a displays a list 51 of the past process contents (execution date, executed function, user configuration contents) together with a guidance 50 of “your past configuration”. Further, in the display example shown in FIG. 5, the display section 12a displays also a return button 52 for instructing return of the display screen to the main menu screen.

The list 51 shown in FIG. 5 includes display columns 55 (55a, 55b, 55c, 55d) of plural items (“No”, “date”, “function”, “user select”) and respective process contents 56 (56a, 56b, 56c, . . . ) made to correspond to the display columns 55 of the respective items. In the list 51, each of the process contents 56 corresponds to one configuration history file. That is, the display section 12a displays the list of the respective process contents including “No” (serial number), “date” (execution date), “function” (executed function), and “user select” (user configuration content) for each of the configuration history files. In the list 51 as stated above, the touch panel 12b receives the selection in unit of each process content. That is, if the user touches a display part of one process content 56 in the list 51, the CPU 21 selects the process content of the display part touched by the user.

Besides, in the display example shown in FIG. 5, the display order of the process contents in the list 51 may be sorted according to the instruction of the user. That is, the CPU 21 may have a sort function of the process contents in the list 51. For example, as the sort function, the CPU 21 rearranges the display order of the process contents 56 in the list 51 in order of date, in order of function, or in order of user configuration content. The CPU 21 executes the foregoing sort function according to the instruction of the user.

In the list 51 shown in FIG. 5, the display columns 55 (55a, 55b, 55c, 55d) of the respective items may function as buttons to instruct sorting by the respective items. In this case, if the user touches the display column 55a shown as “No”, the CPU 21 arranges the respective process contents 56 of the list 51 in order of serial number. Besides, if the user touches the display column 55b shown as “date”, the CPU 21 arranges the respective process contents 56 of the list 51 in order of date. If the user touches the display column 55c shown as “function”, the CPU 21 arranges the respective process contents 56 of the list 51 in order of function. If the user touches the display column 55d shown as “user select”, the CPU 21 arranges the respective process contents 56 of the list 51 in order of user configuration.

If the list 51 is displayed on the display section 12a of the operation panel 12, the CPU 21 waits for input from the user. In this state, if a touch on the display column 55 of some item is detected (Act 18, YES), the CPU 21 arranges the display order of the respective process contents 56 of the list 51 in the order sorted by the touched item (Act 17).

Besides, if a touch on a display part of the process content 56 of the list 51 is detected (Act 19, YES), the CPU 21 configures the respective sections of the digital multi-function peripheral 1 so that the same process as the selected process content is performed (Act 20). Besides, if a touch on a display part of the process content 56 of the list 51 is detected (Act 19, YES), the CPU 21 displays a guidance representing the configuration content based on the selected process content on the display section 12a (Act 21).

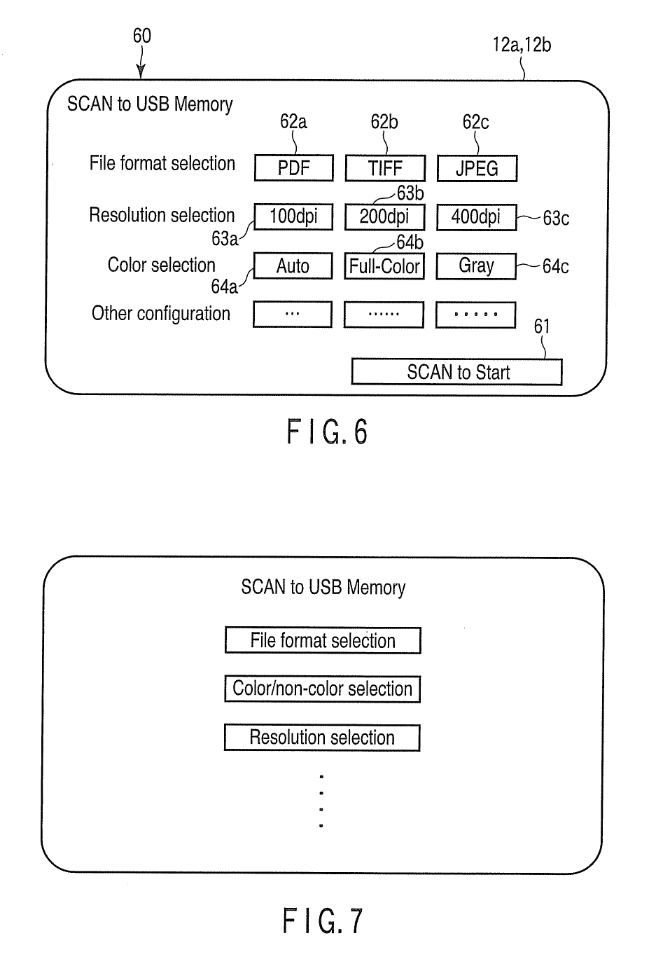

FIG. 6 shows a display example of the guidance representing the configuration content reflecting the process content selected by the user.

In the display example shown in FIG. 6, the display section 12a displays a guidance 60 of a selected function, a start button 61, and various configuration items 62, 63, 64, . . . . Incidentally, FIG. 6 shows the display example in the case of selecting the process content in which the item of “No” shown in FIG. 5 is “3”. That is, the display section 12a displays “SCAN to USB memory” as the guidance 60 of the selected function. The “SCAN to USB memory” corresponds to the function in the process content in which the item of “No” shown in FIG. 5 is “3”. Besides, the display section 12a displays an icon shown as “SCAN Start” as the start button 61. The display content (“SCAN Start”) in the start button 61 also corresponds to the function in the process content in which the item of “No” shown in FIG. 5 is “3”.

In the display example of FIG. 6, the display section 12a displays configuration of file formats as the configuration item 62. In the display example of FIG. 6, the display section 12a displays, as the configuration item 62 of the file formats, an icon 62a shown as “PDF”, an icon 62b shown as “TIFF”, and an icon 62c shown as “JPEG”. Besides, in the display example of FIG. 6, the display section 12a displays (highlights) the icon 62a in a selected state so as to correspond to “PDF” of “user select” in the process content in which “No” shown in FIG. 5 is “3”.

In the display example of FIG. 6, the display section 12a displays configuration of resolution as the configuration item 63. In the display example of FIG. 6, the display section 12a displays, as the configuration item 63 of the resolution, an icon 63a shown as “100 dpi”, an icon 63b shown as “200 dpi”, and an icon 63c shown as “400 dpi”. Besides, in the display example of FIG. 6, the display section 12a displays (highlights) the icon 63c in the selected state so as to correspond to “400 dpi” of “user select” in the process content in which the item of “No” shown in FIG. 5 is “3”.

In the display example of FIG. 6, the display section 12a displays color configuration as the configuration item 64. In the display example of FIG. 6, the display section 12a displays, as the color configuration item 64, an icon 64a shown as “Auto”, an icon 64b shown as “Full-Color”, and an icon 64c shown as “Gray”. Besides, in the display example of FIG. 6, the display section 12a displays (highlights) the icon 64c in the selected state so as to correspond to “Gray” of “user select” in the process content in which the item of “No” shown in FIG. 5 is “3”.

As shown in FIG. 6, the display section 12a displays, as the respective configuration items 62, 63 and 64, plural icons representing configuration contents which can be configured. The configuration content at each configuration item is shown in the display state of the icon. That is, the user recognizes the configuration contents in the respective configuration items by the display state of the icon group of the respective configuration items. Besides, if a configuration content is changed, in the respective configuration items, the user uses the touch panel 12b to select the icon of the configuration content which is desired to be changed. In the display example shown in FIG. 6, the screen functions not only as the guidance screen representing the configuration contents of the respective configuration items but also as the configuration change screen to receive configuration change from the user.

If the display section 12a of the operation panel 12 displays the guidance screen as shown in FIG. 6, the CPU 21 waits for input from the user. In this state, if the user instructs change of the configuration content, that is, if a touch on an icon of one of the configuration items 62, 63 and 64 is detected (Act 22, YES), the CPU 21 changes the configuration content in accordance with the instruction (Act 20). In this case, the CPU 21 displays the guidance screen showing the changed configuration content on the display section 12a (Act 21).

If the user instructs execution of a process, that is, if a touch on the start button 61 is detected (Act 23, YES), the CPU 21 executes the process in accordance with the configuration content displayed on the display section 12a (Act 24).

Besides, at Act 13, if it is determined that the configuration history file does not exist in the external storage device M (Act 13, NO), or if there is no input to the history button 41 (Act 15, NO), the CPU 21 receives an instruction by an operation button on the operation panel 12 (Act 31). Each time the user instructs by the operation button (Act 31, YES), the CPU 21 performs configuration according to the instruction content from the user (Act 32). If the user instructs execution of the process (Act 33, YES), the CPU 21 executes the process in accordance with the present configuration content (Act 24).

If the process is executed in the state where the external storage device M is connected to the external I/F 31, the CPU 21 creates a file of the process content such as executed function, execution date and user configuration content and creates a configuration history file (Act 25). If the configuration history file representing the executed process content is created, the CPU 21 stores the created configuration history file into the external storage device M through the external I/F 31 (Act 26).

In the first operation example, the digital multi-function peripheral stores the configuration history file representing the executed process content into the external storage device connected to the external I/F. Besides, if the external storage device is connected to the external I/F, the digital multi-function peripheral acquires the configuration history file from the external storage device, and presents the user with the process content, as the past process content, represented by the configuration history file acquired from the external storage device connected to the external I/F. If one process content is selected from the past process contents presented to the user, the digital multi-function peripheral performs the same configuration as the selected process content. Accordingly, in the first operation example, the user who connects the external storage device M to the external I/F can easily instruct to perform the configuration of the same content as the past process content stored in the external storage device M.

Next, a second operation example of the digital multi-function peripheral 1 will be described.

First, the second operation example will be schematically described. The second operation example is the example of the operation executed by the digital multi-function peripheral 1 if the external storage device M is connected to the external I/F 31. In this second operation example, if the digital multi-function peripheral 1 detects that the external storage device M is connected to the external I/F 31, an operation screen corresponding to functions executable by using the external storage device M is displayed on the display section 12a.

For example, if only one function can be executed by using the external storage device M connected to the external I/F 31, the display section 12a displays the configuration screen of only the one executable function. Besides, if there are plural functions executable by using the external storage device M connected to the external I/F 31, the display section 12a displays the function selection screen to select one function from the executable functions. The user who connects the external storage device M to the external I/F 31 performs an operation on the operation screen displayed on the display section 12a according to the function executable by using the external storage device M.

FIG. 7 shows a display example of a case where there is only one function using the external storage device (USB memory) M connected to the external I/F 31. In the display example shown in FIG. 7, it is assumed that the function executable by using the USB memory M connected to the external I/F 31 is only the “SCAN to USB memory” function. The display example shown in FIG. 7 does not show the selection screen to select one function from plural functions, but shows the configuration screen of the “SCAN to USB memory” function which is only the one function executable by using the USB memory M. In the display example shown in FIG. 7, a storage file format, a color mode, a read resolution and the like are displayed as the configuration items of the “SCAN to USB memory” function.

Incidentally, as the configuration screen of the “SCAN to USB memory” function, as described in the first operation example, the past process content may be selected from the configuration history files stored in the external storage device (USB memory) M connected to the external I/F 31. However, if the USB memory M stores the configuration history files of plural functions, the display section 12a displays the screen to select the past process content from the configuration history files in which the executed function is the “SCAN to USB memory” function. This can be realized in such a way that the CPU 21 extracts, from the configuration history files stored in the USB memory M, the configuration history file in which the executed function is the “SCAN to USB memory” function.

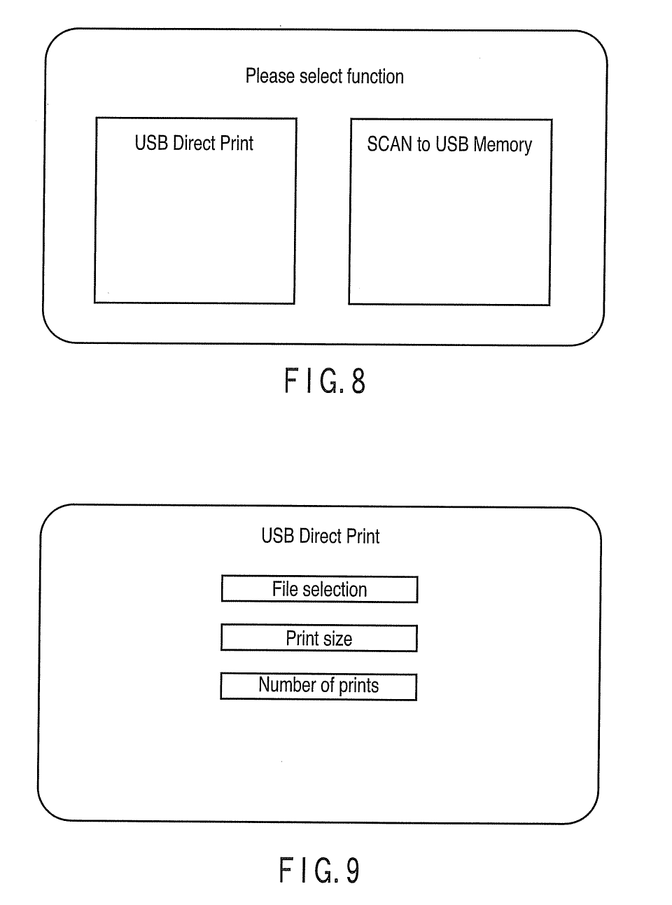

FIG. 8 shows a display example of a case where there are plural functions using the external storage device (USB memory) M connected to the external I/F 31. In the display example shown in FIG. 8, it is assumed that functions executable by using the USB memory M connected to the external I/F 31 are a “SCAN to USB memory” function and a “USB Direct Print” function. In this case, as shown in FIG. 8, the display section 12a displays the selection screen to select one function from the plural executable functions (“SCAN to USB memory” function and “USB Direct Print” function).

If the user selects one function on this selection screen, the display section 12a displays a configuration screen of the selected function. For example, if the user selects the “SCAN to USB memory” function on the selection screen, the display section 12a displays the configuration screen of the “SCAN to USB memory” function as shown in FIG. 7. If the user selects the “USB Direct Print” function on the selection screen, the display section 12a displays the configuration screen of the “USB Direct Print” function as shown in FIG. 9. In the display example shown in FIG. 9, file selection, print size, the number of prints and the like are displayed as configuration items of the “USB Direct Print” function.

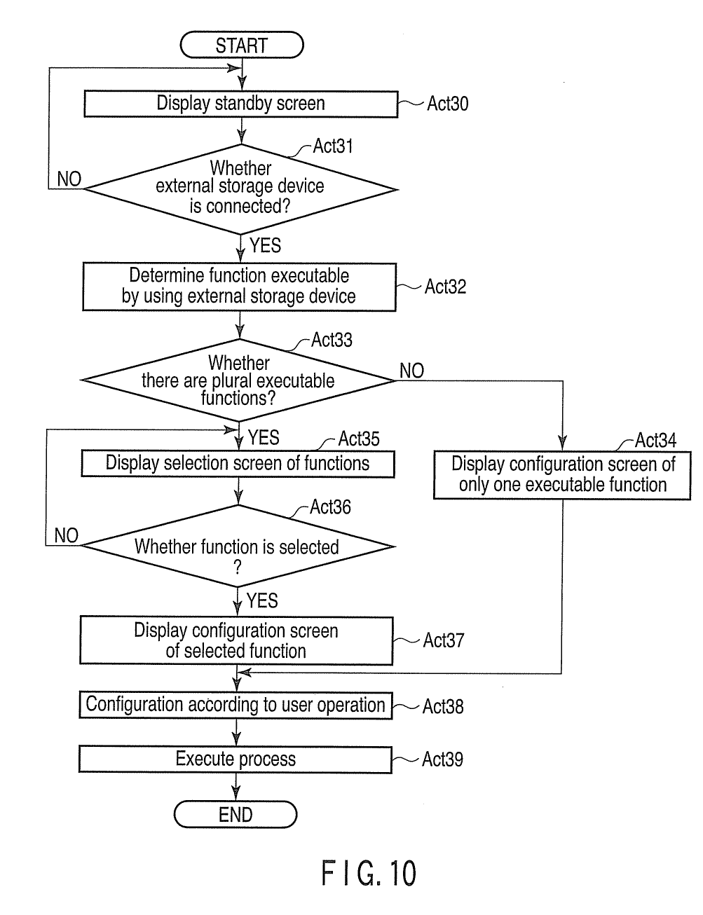

FIG. 10 is a flowchart for explaining the second operation example.

First, in a standby state, the CPU 21 displays a standby screen (main menu screen) on the display section 12a (Act 30). In this state, the CPU 21 executes a task (firmware) to monitor a connection state of the external storage device M to the external I/F 31 (Act 31). In this state, if it is detected that the external storage device M is connected to the external I/F 31 (Act 31, YES), the CPU 21 determines functions executable by using the external storage device M connected to the external I/F 31 (Act 32).

For example, if the digital multi-function peripheral 1 supports only a scan function as a function using the external storage device M, the CPU 21 determines that the function executable by using the external storage device M is only the scan function.

Besides, if the digital multi-function peripheral 1 has the scan function and the print function as functions using the external storage device M, the CPU 21 determines that the functions executable by using the external storage device M are the scan function and the print function.

However, the print function (Direct print function) using the external storage device M can not be executed unless image data for printing is stored in the external storage device M. Thus, the CPU 21 may determine whether or not the print function (Direct print function) using the external storage device M is executable based on whether or not the image data for printing is stored in the external storage device M.

That is, with respect to a function executed by using data stored in the external storage device M, the CPU 21 checks the memory content of the external storage device M and may determine whether or not the function can be executed. Further, if an executable function is determined according to the kind or specification of the external storage device M connected to the external I/F 31, the CPU 21 checks the kind or specification of the external storage device M and may determine the executable function.

If determining the function executable by using the external storage device M connected to the external I/F 31, the CPU 21 determines whether or not there are plural functions determined to be executable by using the external storage device M (Act 33). If it is determined that there is only one function executable by using the external storage device M (Act 33, NO), the CPU 21 displays the configuration screen corresponding to only the one executable function on the display section 12a (Act 34). For example, if the function executable by using the external storage device M is only the “SCAN to USB memory” function, the CPU 21 displays the configuration screen as shown in FIG. 7 on the display section 12a.

Besides, if it is determined that there are plural functions executable by using the external storage device M (Act 33, YES), the CPU 21 displays the selection screen to select one function from the plural executable functions on the display section 12a (Act 35). For example, if the functions executable by using the external storage device M are the “SCAN to USB memory” function and the “USB Direct Print” function, the CPU 21 displays the function selection screen as shown in FIG. 8 on the display section 12a. The user selects an execution function on the function selection screen as stated above.

If a function is selected on the function selection screen (Act 36, YES), the CPU 21 displays the configuration screen of the selected function on the display section 12a (Act 37). For example, if the “SCAN to USB memory” function is selected, the CPU 21 displays the configuration screen as shown in FIG. 7 on the display section 12a. Besides, if the “USB Direct Print” function is selected, the CPU 21 displays the configuration screen as shown in FIG. 9 on the display section 12a.

On the configuration screen as stated above, the user performs configuration of the function executable by using the external storage device M connected to the external I/F 31. The CPU 21 performs various configurations according to the instruction of the user (Act 38). Besides, if the user instructs execution of the process, the CPU 21 executes the process based on the present configuration content (Act 39). Incidentally, if the second operation example is combined with the first operation example and is executed, as the process is executed, the CPU 21 creates a configuration history file of process contents, and stores it in the external storage device M.

In the second operation example, if the external storage device M is connected to the external I/F 31, the optimum operation screen is displayed according to the function executable by using the external storage device M. That is, if the external storage device M is connected to the external I/F 31, and if there is only one function executable by using the external storage device M, the digital multi-function peripheral 1 displays the configuration screen of the function. If the external storage device M is connected to the external I/F 31, and if there are plural functions executable by using the external storage device M, the digital multi-function peripheral 1 displays the selection screen to select one function from those functions. That is, according to the second operation example, if the user merely mounts the external storage device M on the external I/F 31, the function executable by using the external storage device M can be easily configured. Besides, if there are plural functions executable by using the external storage device M connected to the external I/F 31, the user can easily select the function to be executed.

Besides, on the configuration screen of the respective functions displayed in the second operation example, the configuration content may be selected from the process contents represented by the configuration history files acquired by the external storage device M as described in the first operation example. In this case, only one executable function in the configuration history files stored in the external storage device M or the process contents represented by the configuration history files as the execution history of the functions selected by the user are listed as selectable icons. That is, by combining the first operation example and the second operation example, the user can simply select the configuration of the function executable by using the external storage device M connected to the external I/F 31 from the past process contents.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus for processing image data, comprising:
an interface configured to connect to an external storage device;
an acquisition section configured to acquire a configuration history file representing a past executed process content stored in the external storage device connected to the interface;
a configuration section configured to perform configuration for performing a same process as the process content represented by the configuration history file acquired by the acquisition section from the external storage device connected to the interface; and
a processing section configured to process the image data in accordance with the process content configured by the configuration section.

2. The apparatus of claim 1, further comprising:
a filing section configured to create a configuration history file of data representing a content of a process executed in a state where the external storage device is connected to the interface; and
a storage section configured to store the configuration history file created by the filing section and representing the process content into the external storage device connected to the interface.

3. The apparatus of claim 1, further comprising
an instruction section configured to instruct one process content from process contents represented by respective configuration history files if the acquisition section acquires the plurality of configuration history files from the external storage device connected to the interface, wherein
the configuration section configures to perform a same process as the process content instructed by the user through the instruction section.

4. The apparatus of claim 1, further comprising
a display section configured to display, in a list, process contents selectable by the user from the process contents of the configuration history files acquired by the acquisition section, wherein
the instruction section instructs one process content from the process contents listed on the display section.

5. The apparatus of claim 4, wherein
the instruction section includes a touch panel provided on the display section.

6. The apparatus of claim 4, wherein
if the external storage device is connected to the interface, the display section displays a configuration history button which can be instructed through the instruction section on an operation screen, and after the configuration history button is instructed through the instruction section, process contents selectable by the user are listed from the process contents of the configuration history files acquired by the acquisition section from the external storage section to be displayed.

7. The apparatus of claim 4, further comprising
a sort section configured to sort the listed process contents displayed on the display section in order of an item instructed by the user.

8. The apparatus of claim 4, wherein
if the instruction section instructs one process content, the display section displays a configuration state of each of configuration items based on the instructed process content.

9. The apparatus of claim 8, wherein
the display section displays a configuration key group selectable through the instruction section for the respective configuration items, and displays a configuration key corresponding to a present configuration in a selected state.

10. The apparatus of claim 9, wherein
if a configuration key different from the present configuration is instructed through the instruction section, the configuration section changes the present configuration to a configuration content corresponding to the instructed configuration key.

11. The apparatus of claim 4, further comprising:
a detection section configured to detect whether the external storage device is connected to the interface; and
a determination section configured to determine a function executable by using the external storage device if the detection section detects that the external storage device is connected to the interface, wherein
if the determination section determines that there is only one function executable by using the external storage device, the display section displays, in a list, process contents represented by the configuration history file including an execution history of the function determined to be executable by using the external storage device.

12. The apparatus of claim 4, further comprising:
a detection section configured to detect whether the external storage device is connected to the interface; and
a determination section configured to determine a function executable by using the external storage device if the detection section detects that the external storage device is connected to the interface, wherein
if the determination section determines that there are a plurality of functions executable by using the external storage device, the display section displays a guidance to urge selection of one function from the plurality of functions determined to be executable by using the external storage device, and if one function is selected, the display section displays, in a list, the process contents represented by the configuration history file including an execution history of the function.

13. An image processing method comprising:
acquiring a configuration history file representing a past executed process content from an external storage device connected to an interface;
performing configuration for performing a same process as the process content represented by the configuration history file acquired from the external storage device connected to the interface; and
processing image data in accordance with the configured process content.

14. The method of claim 13, further comprising:
creating a configuration history file of data representing a content of a process executed in a state where the external storage device is connected to the interface; and
storing the created configuration history file representing the process content into the external storage device connected to the interface.

15. The method of claim 13, wherein
if a plurality of configuration history files are acquired from the external storage device connected to the interface, a user instructs one process content from process contents represented by the respective configuration history files, and
the configuration for performing the same process as the process content instructed by the user is performed.

16. The method of claim 13, further comprising
displaying, in a list, process contents selectable by the user from the process contents represented by the configuration history files acquired from the external storage device on a display section, wherein
one process content is instructed from the process contents listed on the display section.

17. The method of claim 16, further comprising
sorting the process contents listed on the display section in order of an item instructed by the user.

18. The method of claim 16, further comprising
displaying, if one process content is instructed from the process contents listed on the display section, a configuration state of each of configuration items based on the instructed process content on the display section.

19. The method of claim 18, further comprising
displaying a configuration key group selectable for the respective configuration items on the display section, and displaying a configuration key corresponding to a present configuration in a selected state.

20. The method of claim 19, wherein
if a configuration key different from the present configuration is instructed in the configuration keys displayed on the display section, the present configuration is changed to a configuration content corresponding to the instructed configuration key.
